(19) United States
(12) Patent Application Publication
(10) Pub. No.: US 2011/0123744 A1
(43) Pub. Date: May 26, 2011

(54) SEPARATION-RESISTANT GAS-BARRIER LAMINATE

(76) Inventors: Hiroyuki Sato, Tokyo (JP); Yoshinori Suzuki, Tokyo (JP); Moriaki Arasaki, Tokyo (JP); Takashi Sato, Tokyo (JP); Satoru Suzuki, Tokyo (JP)

(21) Appl. No.: 13/055,236

(22) PCT Filed: Jul. 3, 2009
(86) PCT No.: PCT/JP2009/062214

§ 371 Date: Jan. 21, 2011

(30) Foreign Application Priority Data
Jul. 23, 2008 (JP) 2008-190213

(51) Int. Cl. B32B 27/08; B32B 1/02

(52) U.S. Cl. 428/36.6; 428/141

(57) ABSTRACT

In a gas-barrier laminate having a layer structure of aromatic polyester resin/polyglycolic acid resin/aromatic polyester resin, a small amount of an aromatic polyester resin polymerized with a germanium compound (catalyst) is blended to the polyglycolic acid resin forming the core layer, thereby surface-roughening the polyglycolic acid resin layer. As a result, the peeling resistance between the polyglycolic acid resin/aromatic polyester resin layers is practically improved while maintaining a good gas-barrier property.

### TECHNICAL FIELD

The present invention relates to a gas-barrier laminate suitable for use as a packaging material or container having gas-barrier property.

### BACKGROUND ART

Along with progress of plastics forming technique, packaging materials or containers comprising various thermoplastic resins for content materials, such as food and drugs, have been widely used. Among these, an aromatic polyester resin, especially polyethylene terephthalate (that is, terephthalic acid-ethylene glycol polycondensation resin) generally called “PET resin”, is particularly used widely as a packaging material for beverages in the form of a so-called “PET bottle” because of its transparency, hardness, moldability, etc. In such a use, in order to mainly avoid the degradation of the content by invasion (penetration) of oxygen from the exterior or the deterioration of a content material, such as a carbonated beverage, by penetrative dissipation of the effective dissolved gas component, it is desired to improve the gas-barrier property of the PET resin.

It has been also proposed to improve the gas-barrier property of PET resin by composition with a known gas-barrier resin. For example, Patent document 1 discloses a PET bottle comprising PET resin blended with MXD6 nylon (i.e., polymetaxylilene adipamide) which is a gas-barrier resin. Ethylene-vinyl alcohol copolymer (EVOH) is also known as another gas-barrier resin, and EVOH has a high gas-barrier property in a low-humidity environment, but the gas-barrier property falls at a high humidity. As a barrier material in place of the above, the group of the present inventors is proceeding with an application development of polyglycolic acid (PGA) resin which is an aliphatic polyester having a gas-barrier property that is several times as large as (or less than one second or third of permeability as) that of MXD6 nylon or EVOH, and the gas-barrier property is less liable to decrease even at a high humidity compared with EVOH. Although there is no decrease of short-term barrier property under high humidity, however, the polyglycolic acid resin shows a molecular weight decrease tendency due to a hydrolysis in a long run, and the gas-barrier property thereof also falls as a result of the molecular weight decrease. Accordingly, a packaging material obtained by blending the polyglycolic acid resin with PET resin, may be provided with an improved gas-barrier property, which however is hard to maintain in the long run.

As a result of further study, the group of the present inventors has found that a packaging or container material formed by sandwiching a polyglycolic acid resin layer with a pair of aromatic polyester resin layers to suppress the contact with water in the content material and external atmosphere water, can maintain a good gas-barrier property even in a long period of time, and has made a series of proposals regarding a laminate suitable as a package or container material, and process for production thereof (Patent documents 2-5). However, there has been found a problem that a bottle-shaped container formed in the above-described manner is liable to cause peeling at a boundary between the aromatic polyester layer and the polyglycolic acid resin layer when it is filled with a content and subjected to an impact as by falling thereof.
Patent document 1: JP 2001-106219A
Patent document 2: WO03/099562A1
Patent document 3: WO2004/087813A1
Patent document 4: WO2005/032800A1
Patent document 5: WO2005/072944A1.

### DISCLOSURE OF INVENTION

Accordingly, a principal object of the present invention is to provide a laminate with a suppressed peelability or separatability at a boundary and suitable for providing a package or container material capable of retaining a persistent good gas-barrier property.

The peeling-resistant gas-barrier laminate of the present invention has been developed in order to accomplish the above-mentioned object and comprises a pair of aromatic polyester resin layers, and a gas-barrier resin layer sandwiched between the aromatic polyester resin layers; wherein the gas-barrier property resin layer comprises a mixture of 100 wt. parts of a polyglycolic acid resin and 1-10 wt. parts of an aromatic polyester resin polymerized with a germanium compound (catalyst), and the gas-barrier resin layer is provided with a surface roughness of 4-1000 nm.

In order to prevent inter-layer peeling in an aromatic polyester resin/polyglycolic acid resin/aromatic polyester resin laminate, it may be conceived of inserting a layer of an adhesive resin, such as maleic acid-modified polyolefin resin, between the aromatic polyester resin and polyglycolic acid resin layers. In this case, however, it is necessary to change the S-layer structure into a 5-layer structure and it is inevitable to incur a cost increase accompanying complication of the co-extrusion apparatus, etc. Then, in order to accomplish the above-mentioned object in the conventional laminate of aromatic polyester resin/polyglycolic acid resin/aromatic polyester resin, the present inventors aimed at suppressing interfacial peeling by incorporating in the polyglycolic acid resin layer an aromatic polyester resin in an amount sufficiently small so as to avoid the deterioration of the gas-barrier property, thereby improving the chemical affinity with the adjacent aromatic polyester resin layer. As a result, a substantially desired level of improvement in peeling resistance was accomplished. Unexpectedly, however, it has become clear that the reason for the improvement is attributable to an effect of physical engagement of the adjacent layers at the boundary through surface-roughening of the polyglycolic acid resin layer during the formation thereof due to mixing of the aromatic polyester resin and the corresponding surface roughening of the adjacent aromatic polyester resin layer, rather than the improvement in affinity at the polyglycolic acid resin/aromatic polyester resin interface. On the other hand, there is observed a tendency of a lowering in thermal stability of the polyglycolic acid resin layer due to mixing of the aromatic polyester resin, causing an increase in glycolide content and an increased rate of molecular weight lowering, to result in a lowering in persistence of gas-barrier property.

As a result of further study, the present inventors have arrived at a presumption such that a polycondensation catalyst used for producing the aromatic polyester resin blended with polyglycolic acid resin functions as a promoter for glycolide generation reaction due to decomposition of the polyglycolic acid resin. As a polycondensation catalyst for aromatic polyester resin, an antimony compound, a germanium compound, a tin compound, a zinc compound, an aluminum compound, a titanium compound, etc., are generally used. Further, among the above, germanium compound (catalyst) has been found to show less noticeable promoter effect for the glycolide generation reaction due to decomposition of the polyglycolic acid resin. Then, a polyglycolic acid resin blended with a small amount of an aromatic polyester resin obtained with a germanium compound (catalyst) was used to form a laminate of aromatic polyester resin/polyglycolic acid resin/aromatic polyester resin, whereby it has been confirmed possible to provide a laminate with suppressed interfacial peeling while inhibiting the glycolide generation reaction due to decomposition of polyglycolic acid resin, thus arriving at the present invention.

### BEST MODE FOR PRACTICING THE INVENTION

### Aromatic Polyester Resin

The peeling-resistant gas-barrier laminate of the present invention has a layer structure of aromatic polyester resin/gas-barrier property resin/aromatic polyester resin, and thus an aromatic polyester resin is included as a main resin component. Specific examples thereof may include: aromatic polyesters, such as polyethylene terephthalate, polytrimethylene terephthalate, polybutylene terephthalate, polyhexamethylene terephthalate, polyethylene-2,6-naphthalate, polytrimethylene-2,6-naphthalate, polybutylene-2,6-naphthalate, polyhexamethylene-2,6-naphthalate, polyethylene isophthalate, polytrimethylene isophthalate, polybutylene isophthalate, polyhexamethylene isophthalate, poly 1,4-cyclohexanedimethanol terephthalate, and polybutylene adipate terephthalate, etc., and polyethylene terephthalate is especially preferred. Herein, “polyethylene terephthalate” (hereafter sometimes abbreviated as “PET”) is intended to inclusively mean polymers mainly comprising a terephthalic acid unit derived from terephthalic acid or its ester derivative, and an ethylene glycol unit derived from ethylene glycol or its ester derivative, possibly replacing at most 10 mol % of each of the above units with another dicarboxylic acid, such as phthalic acid, isophthalic acid or naphthalene 2,6-dicarboxylic acid, or a diol such as diethylene glycol, or further with a hydroxycarboxylic acid, such as glycolic acid, lactic acid, or hydroxybenzoic acid.

The aromatic polyester resin may preferably have an intrinsic viscosity (IV) as a measure of molecular weight in the range of 0.6 to 2.0 dl/g, more preferably 0.7-1.5 dl/g. Too low an intrinsic viscosity results in difficulty of shaping, and too high an intrinsic viscosity results in evolution of a large shearing heat.

Residual polycondensation catalyst contained in the aromatic polyester resin forming a pair of the aromatic polyester resin layers sandwiching the gas-barrier resin layer contributes little to decomposition promotion of polyglycolic acid resin in the adjacent gas-barrier resin layer. Accordingly, aromatic polyester resins obtained by not only a germanium compound (catalyst) but also an antimony compound, a tin compound, a zinc compound, an aluminum compound, a titanium compound, etc., as polycondensation catalysts, may be used without adverse effects. Especially, an aromatic polyester resin polymerized with an antimony (Sb) compound (catalyst) is not preferred for blending with polyglycolic acid resin directly, since Sb has the promoter action for the decomposition reaction of the above-mentioned polyglycolic acid resin, but is preferred for providing a rigid container since Sb may act as a nucleating agent to provide a high crystallinity. Such a polyethylene terephthalate obtained with such an antimony compound (catalyst) (hereinafter sometimes abbreviated as “PET (Sb)”) is also commercially available, for example, “1101” made by KoSa Co., and “9921” made by Eastman Kodak Co., etc., and these commercially available products can be used as they are in the present invention.

Although the aromatic polyester resins forming a pair of the aromatic polyester resin layers can be different, but are generally preferably a common resin so as to simplify the extrusion apparatus design.

(Gas-Barrier Resin)

The gas-barrier resin layer sandwiched between a pair of aromatic polyester resin layers comprises a polyglycolic acid resin as a principal component, and is formed through melt-kneading with an aromatic polyester resin obtained by use of a germanium compound (catalyst). The polyglycolic acid resin used in the present invention may preferably be a polyglycolic acid resin obtained by the ring-opening polymerization of glycolide. A polyglycolic acid resin obtained by the polycondensation of glycolic acid is not provided with a high molecular weight, which is desirable for providing desired mechanical strength to the resultant resin composition, and is caused to contain increased remaining terminal hydroxyl groups and carboxylic group, so that it becomes difficult to obtain the effect of preventing the glycolide generation by the decomposition under melt-processing with the aromatic polyester resin aimed at by the present invention.

The polyglycolic acid resin (hereinafter often called “PGA resin”) used by the present invention may be homopolymer of glycolic acid (PGA) consisting only of a glycolic acid recurring unit denoted by —(O.CH₂.CO)— obtained by ring-opening polymerization of glycolide alone, and also ring-opening copolymerization products of glycolide with annular comonomers, such as lactides (cyclic dimer esters of hydroxycarboxylic acids other than glycolide) including lactide (cyclic dimer ester of lactic acid), ethylene oxalate (i.e., 1,4-dioxane-2,3-one), lactones (e.g., beta-propiolactone, beta-butyrolactone, beta-pivalolactone, gamma-butyrolactone, delta-valerolactone, beta-methyl-delta-valerolactone, epsilon-caprolactone), carbonates (e.g., trimethylene carbonate, etc.), ethers (e.g., 1,3-dioxane etc.), ether esters (e.g., dioxanone, etc.), and amides (epsilon-caprolactam, etc.). However, in order to maintain a high gas-barrier property-improvement effect to the aromatic polyester resin, it is preferred that the above-mentioned glycolic acid recurring unit in the PGA resin is 70 wt. % or more, and it is particularly preferred to use PGA homopolymer.

It is preferred that the PGA resin has a molecular weight (Mw (weight-average molecular weight) as measured based on polymethyl methacrylate by gel permeation chromatography using a hexafluoro-propanol solvent; the same as hereafter, unless otherwise noted specifically) of above 100,000, particularly in the range of 120,000-500,000. If 100,000 or below, it becomes difficult to obtain a molded product of a desired strength through melt-kneading with an aromatic polyester resin. On the other hand, if the molecular weight of PGA resin is excessively large, heat generation due to the shearing at the time of the melt-kneading increases, thus being liable to result in coloring of the product. Melt viscosity can be used as another measure of preferred molecular weight of PGA resin. More specifically, it is preferred for the PGA resin to show a melt viscosity of 100 to 20000 Pa-s, preferably 100 to 10000 Pa-s, particularly 200-2000 Pa-s, as measured at 270° C. and a shear rate of 122 sec⁻¹.

In the present invention, it is preferred to use a PGA resin obtained by ring-opening polymerization under heating of glycolide (and a small quantity of a cyclic comonomer as needed). The ring-opening-polymerization is substantially performed by bulk polymerization. The ring-opening polymerization is usually performed at a temperature of 100° C. or more in the presence of a catalyst. In order to suppress the decrease of the molecular weight of PGA resin in melt-kneading, the residual glycolide content in the PGA resin should preferably be suggested to less than 0.5 wt. %, more preferably less than 0.2 wt. %, particularly less than 0.1 wt. %. As a result, the residual glycolide content in the resultant composition of the present invention can be reduced. As the ring-opening polymerization catalyst, oxides, halide, carboxylate, alkoxide, etc., of tin, titanium, aluminum, antimony, zirconium, zinc, germanium, etc., may be used. Especially, a tin compound, particularly tin chloride, is preferably used in view of its polymerization activity and colorlessness. However, as the increase in residual content of tin (counted as metal) in the PGA resin is liable to increase the glycolide formation during the melt-processing with aromatic polyester resin or the processing, the residual tin content (counted as metal) should preferably be suppressed to 70 ppm or less (about 100 ppm or less as tin chloride).

The gas-barrier resin layer in the laminate of the present invention contains the PGA resin described above as a principal component, and is formed as a melt-kneaded and shaped layer of the PGA resin and a small amount of aromatic polyester resin. For formation of a gas-barrier resin layer, among the aromatic polyester resins described above, one obtained with a germanium compound (catalyst) (hereafter, sometimes abbreviated as “aromatic polyester resin (Ge)”) is particularly used. Although a copolymer polyester may also be used, homo-polyester (e.g., polyethylene terephthalate) with little gas-barrier reduction effect at the time of blending with the PGA resin, is more preferred. As a germanium compound (catalyst), an organic complex or oxide of germanium is preferred, and particularly an oxide is preferred. The germanium content in the aromatic polyester resin, is usually at least 1 ppm and less than 1000 ppm, and the use of a larger amount causes coloring and manufacturing cost increase of the product aromatic polyester resin. Although the aromatic polyester resin polymerized with another polymerization catalyst can be mixed in a slight amount in the recycling process of an aromatic polyester resin molded product, such a slight amount need not be questioned, if it is a range of allowing the reduction of the glycolide formation during the melt-processing with the polyglycolic acid resin.

The polyethylene terephthalate obtained with such a germanium compound (catalyst) (hereinafter sometimes abbreviated as “PET (Ge)”) is also commercially available, and examples thereof may include: “J125S” made by Mitsui Kagaku K. K., “WPTS” made by Kanebo Gohsen K. K. and “KS710B-4” made by K. K. Kuraray, and may be used as they are.

The gas-barrier resin layer of the laminate of the present invention comprises a mixture or blend of 100 wt. parts of the PGA resin and 1-10 wt. parts of the aromatic polyester resin (Ge), described above. At an aromatic polyester resin (Ge) content of below 1 wt. part, the peeling resistance-improvement effect due to surface roughening becomes scarce, and above 10 wt. parts, the gas-barrier property of the resultant gas-barrier resin layer and therefore of the laminate is lowered.

Although the mixing is performed by melt-kneading in advance of the laminate formation (preferably, coextrusion laminate formation, inclusive of injection molding) for providing the laminate, the manners thereof can be diverse to some extent. Examples of the manners of mixing may include: (a) mixing the PGA resin pellets and aromatic polyester resin pellets, formed separately, just before the laminate forming; (b) preparing mixture pellets by melt-extrusion preliminarily in advance of the laminate formation; and (c) in a process of converting pulverized PGA resin into pellets, causing the aromatic polyester resin in a molten state to join with the PGA resin to form mixture pellets.

The melt-kneading may be performed by means of a single-screw or twin-screw extruder, and generally the temperature setting thereof, when the aromatic polyester resin kneaded is PET, may be in the range of from the melting point of PGA of 220° C. to the melting point of PET+30° C. (about 290° C.). At less than 220° C., the screw load becomes excessive due to poor melting of PGA so that the extrusion becomes difficult or impossible. On the other hand, if it exceeds 290° C., the thermal decomposition of PGA will be accelerated, and troubles, such as coloring, a lowering in barrier property, and a lowering in strength, will occur.

Anyway, it is preferred to add stabilizers, such as thermal stabilizer and carboxyl group-capping agent, to at least one (preferably to the PGA resin) of the aromatic polyester resin and the PGA resin, in advance of the melt-kneading. Examples of the thermal stabilizer may include: phosphorus compounds, inclusive of, phosphoric acid, trimethyl phosphate, triphenyl phosphate, tetra-ethylammoniumhydroxide-3,5-di-t-butyl-4-hydroxybenzyl-phosphoric acid diethyl ester (commercially available as “Irganox1222” made by Ciba-Geigy A.G.), calcium diethylbis [[3,5-bis(1,1-dimethyl ethyl)-4-hydroxyphenyl]methyl] phosphate (“Irganox 1425WL”), tris(2,4-di-t-butylphenyl) phosphite (“Irganox 168”), and further, phosphate esters having pentaerythritol skeleton, such as cyclic neopentanetetraylbis(2,6-di-t-butyl-4-methylphenyl) phosphite (“ADEKASTAB PEP-36”, made by Adeka Corp.), phosphorus compounds having at least one hydroxyl group and at least one long-chain-alkyl-ester group, such as an almost equi-molar mixture of mono- and di-stearyl phosphate (“ADEKASTAB AX-71”); hindered phenol compounds, such as tetrakis [methylene-3 (3,5′-di-t-butyl-4′-hydroxyphenyl) propionate methane] (“Irganox 1010”) etc.; hydrazine compounds having a —CO—NHNH—CO— unit, such as bis[2-(2-hydroxybenzoyl) hydrazine] dodecanoic acid, N,N′-bis[3-(3,5-di-t-butyl-4-hydroxyphenyl] propionyl] hydrazine, and further triazole compounds, such as 3-(N-salicyloyl) amino-1,2,4-triazole, generally functioning as a deactivator to a polyester polymerization catalyst.

The thermal stabilizer may be added in an amount of ordinarily 0.001-5 wt. parts, preferably 0.003-3 wt. parts, more preferably 0.005-1 wt. part, per 100 wt. parts of the PGA resin. The addition in excess of 5 wt. parts, is liable to cause the decomposition of the thermal stabilizer per se, thus leading to troubles, such as coloring, a lowering in barrier property, and a lowering in strength.

As the carboxyl group-capping agent, a carbodiimide compound, an oxazoline compound, etc., may be blended at a ratio of 1 wt. % or less of the PGA resin.

In case where the PGA resin and/or the aromatic polyester resin (Ge) already contain such stabilizers as described above, they can be used as they are, or such stabilizers can be further added as needed.

(Laminate Forming)

The laminate of the present invention having a layer structure of aromatic polyester resin/gas-barrier resin/aromatic polyester resin, may be formed through coextrusion laminate forming by using the aromatic polyester resin (preferably in the form of pellets) for forming a pair of the aromatic polyester resin layers, and the PGA resin pellets and the aromatic polyester resin (Ge) pellets (or their mixture pellets) for forming the gas-barrier resin layer, prepared as described above.

The laminate of the present invention is relatively rigid and may suitably be formed as a laminate in the form of a hollow container by injection blow molding, but it is also possible to form an extrusion laminate sheet, followed by sheet forming thereof into a deep-drawn container, etc.

As for the forming temperature, when the aromatic polyester resin is PET, the extrusion or injection temperature for the pair of PET layers may be about 270-320° C., and the extrusion or injection temperature for the gas-barrier resin layer may be about 220-290° C., preferably about 240-270° C. If the gas-barrier resin layer extrusion or injection temperature is below 220° C., the screw load becomes excessive due to poor melting of the PGA, and the extrusion becomes difficult or impossible. On the other hand, in excess of 290° C., the thermal decomposition of PGA will be accelerated, resulting in troubles, such as coloring, a lowering in barrier property, and a lowering in strength.

The formation of a hollow container (bottle) may be performed by so-called “hot parison process” wherein a laminate formed by injection molding is subjected to stretch-blowing before crystallization of the aromatic polyester resin, or by so-called “cold-parison process” wherein a laminate after injection molding is quenched to form an amorphous product (called a preform), which is then re-heated to a temperature of at least Tg (about 60° C.) of the aromatic polyester resin and subjected to stretch-blowing. A suitable temperature in the case of carrying out the stretch-blowing of the laminate of the present invention by the cold-parison process is about 90-130° C.

When forming a bottle as an example of the laminate product, the thickness of each layer may change with positions, but it is common at the bottle body part that the thickness is 50-200 μm for each of a pair of aromatic polyester resin layers and about 0.1-50 μm for the gas-barrier resin layer, and total thickness is about 100.1-450 μm. Further, the weight ratio of the core layer comprising the gas-barrier resin to the whole bottle weight may be 0.1 to 10%, preferably 0.5 to 5%, more preferably 0.7 to 3.5%.

As a step during the laminate formation, or a subsequent separate step, it is advantageous that the laminate is stretched uniaxially or biaxially for the formation of a rough surface of the gas-barrier resin layer. The stretching ratio may preferably be at least 4 times, most preferably 6-12 times, in terms of an areal ratio.

The surface roughness formed in the gas-barrier resin layer, may preferably be 4-1000 nm, more preferably 4.2-500 nm. At less than 4 nm, the peeling resistance-improvement effect is scarce, and above 1000 nm, the peeling resistance-improvement effect will fall again due to void formation. The surface roughness is still more preferably 4.2 to 100 nm, particularly preferably 4.4-50 nm, and most preferably 4.4-20 nm.

### EXAMPLES

Hereinbelow, the present invention will be described more specifically based on Examples and Comparative Examples. The characteristic values described herein including the following Examples are based on those measured or evaluated according to the following methods.

[Melt Viscosity]

A polymer sample was placed in a drier at 120° C. and contacted with dry air to provide a moisture content below 50 ppm as measured by means of a Karl Fischer moisture meter equipped with a vaporizer (“CA-100” (Vaporizer: “VA-100”) made by Mitsubishi Kagaku K.K.). The sample was used for measurement of a melt viscosity (MV).

<Melt Viscosity (MV) Measurement Conditions>

Apparatus: “CAPIROGRAPH 1-C”, made by K.K. Toyo Seiki.
Capillary: 1 mm dia.×1 mm-L.

### Temperature: 240° C.

Shear rate: 122 sec.⁻¹.

[Intrinsic Viscosity]

A PET sample in an amorphous state was dissolved in phenol/1,1,2,2-tetrachloroethane and subjected to measurement of intrinsic viscosity (IV, unit: dl/g) by means of an Ubbelohde viscometer No. 1 (viscometer constant: 0.1173) according to JIS K7390.

[Molecular Weight]

About 10 mg of each polymer sample (PGA or PGA/PET blend) was dissolved in 0.5 ml of high-grade dimethyl sulfoxide on an oil bath at 150° C. The solution was cooled by cold water, and a 5 mM-sodium trifluoroacetate solution in hexafluoro-isopropanol (HFIP) was added to the solution up to a total volume of 10 ml. The solution was filtered through a 0.1 μm-membrane filter of PTFE and then injected into a gel permeation chromatography (GPC) apparatus to measure a weight-average molecular weight (Mw). Incidentally, the sample solution was injected into the GPC apparatus within 30 min. after the dissolution. In the case of a bottle sample, the bottle was disintegrated to take out the gas-barrier resin layer, from which pieces originated from the PET layers were removed by tweezers to provide a sample for the above measurement.

<GPC Measurement Conditions>
Apparatus: “Shodex-104”, made by Showa Denko K.K.
Columns: 2 columns of “HFIP-606M” connected in series with one pre-column of “HFIP-G”.
Column temperature: 40° C.
Fluent: 5 mM-sodium trifluoroacetate solution in HFIP.
Flow rate: 0.6 ml/min.
Detector: RI (Differential refractive index detector)
Molecular weight calibration: Performed by using 7 species of standard polymethyl methacrylate having different molecular weights.

[Glycolide (GL) Content]

To about 100 mg of each polymer sample, 2 mL of dimethyl sulfoxide containing 4-chlorobenzophenone at a concentration of 0.2 g/L was added, and the mixture was heated at 150° C. for about 5 min. to dissolve the sample, followed by cooling to room temperature and filtration. Then, 1 μL of the filtrate solution was injected into a gas chromatography apparatus to effect the measurement. In the case of a bottle sample, the bottle was disintegrated to take out the gas-barrier resin layer to provide a sample for the above measurement.

<Gas Chromatography Conditions>
Apparatus: “GC-2010” made by K.K. Shimadzu Seisakusho)
Column: “TC-17” (0.25 mm in diameter×30 mm in length).
Column temperature: Held at 150° C. for 5 min., heated at 270° C. at a rate of 20° C./min. and then held at 270° C. for 3 min.
Gasification chamber temperature: 180° C.
Detector: FID (hydrogen flame ionization detector) at temperature of 300° C.

[Carboxylic Acid Concentration]

Each bottle was disintegrated to take out the gas-barrier resin layer, and about 0.2 g thereof was weighed as a sample and completely dissolved in 10 mL of high-grade dimethyl sulfoxide on an oil bath at 150° C. in about 3 min. To the solution, 30 μL of about 0.1% Bromothymol Blue/methanol solution was added, and then 0.001-normal 1,8-diazabicyclo[5.4.0]-undeca-7-ene was gradually added until a terminal point when no change in b-value was detected by a differential colorimeter (“CR-400”, made by Konica Minolta Sensing K.K.). From the amount of the solution added up to the terminal point, a carboxylic acid concentration was calculated in terms of equivalent per 1 t (ton) of the gas-barrier resin (eq./t).

[Moisture Resistance Evaluation]

After being filled up with deionized water and covered with a lid, each bottle was placed in a thermo-hygrostat vessel maintained at a temperature of 50° C. and 80%-relative humidity. At this time, the inside of the bottle had become 100%-humidity, so that the PGA layer in a bottle was assumed to be at 90%-humidity. Each bottle was periodically picked out of the thermo-hygrostat vessel, and the PGA layer was taken out by disintegrating the bottle. The-thus recovered PGA samples were subjected to gel permeation chromatography measurement to obtain a curve of molecular weight change with time, form which a number of days until the molecular weight decreased to 70,000, was determined. This is because the decrease of gas-barrier property cannot be disregarded empirically at a molecular weight below 70,000.

[Surface Roughness Measurement]

For each bottle, an outer PET layer was removed to expose the PGA layer, of which the surface was observed through a desk probe microscope. Arbitrarily selected 5 cross sections of the resultant surface picture were subjected to profile analysis to measure central axis-average roughness values (JIS B0601), of which the average was taken as a surface roughness of the sample.

<Surface Roughness Measurement Conditions>

Apparatus: “Nanopics 1000”, made by Seiko Instruments K.K.
Scanning mode: Dumping mode
Scanning area at one section: 100 μm×100 μm
Scanning velocity: 130 flames/sec.

[Evaluation of Peelability]

Each bottle (having an inner volume of 300 mL) was filled up with carbonated water, closed with a lid, and then dropped from a height of 2 m onto a concrete-made floor. After dropping 20 bottles for each condition, the number of bottles having caused peeling was counted.

[Production of PGA Pellets]

To PGA (made by Kureha Corporation; Melt viscosity (at 240° C. and a shear rate of 122 sec ⁻¹)=1178 Pa·s), an almost equi-molar mixture of mono- and di-stearyl acid phosphates (“ADEKASTAB AX-71”, made by K.K. ADEKA, hereafter abbreviated as “thermal stabilizer AX-71”) as a thermal stabilizer in a proportion of 200 ppm with respect to the PGA and 0.3 wt. % with respect to the PGA of N,N-2,6-diisopropylphenylcarbodiimide (made by Kawaguchi Kagaku Kogyo K.K.) as a carboxyl group-capping agent, were added, and the resultant mixture was extrude through a twin-screw extruder to obtain PGA pellets. The thus-obtained PGA pellets were heat-treated at 180° C. for 17 hours in a drier with a nitrogen atmosphere.

The PGA pellets exhibited a weight-average molecular weight of 208,744 and a glycolide content of 0.04 wt. %. The thus-obtained PGA pellets were used in the following Examples.

### <Extrusion Conditions>

Extruder: “TEM-41SS”, made by Toshiba Kikai K.K.
Temperature set: The sections C1-C10 disposed sequentially from the discharge position and the die were set to temperatures of 200° C., 230° C., 250° C., 260° C., 260° C., 260° C., 260° C., 250° C., 250° C., 240° C. and 240° C., respectively.

### Example 1

100 wt. parts of the above-prepared PGA pellets and 1 wt. part of pellets of polyethylene terephthalate obtained by use of germanium catalyst (PET (Ge)) (“J125S” made by Mitsui Kagaku K.K.; germanium content of 28 ppm and antimony content of 0 ppm, respectively, in PET; IV=0.77, and melting point=255° C.) were blended uniformly in a dry state. A multilayer injection molding machine equipped with a mold for forming a preform for stretch-blowing, was used for injecting polyethylene terephthalate with an IV of 0.80 through one injection molding machine to form inner and outer layers and for injecting the PGA-PET pellet blend obtained above through another injection molding machine to form a core layer, simultaneously into the mold, thereby forming the preform. At this time, the injection molding machine for the core layer was set to a cylinder temperature of 255° C. and a hot runner temperature of 255° C., and the injection molding machine for the inner and outer layers was set to a cylinder temperature of 290° C. and a hot runner temperature of 290° C. The weight of the obtained preform was about 21 g, the weight of the core layer occupied 1 to 1.5% of the whole preform weight, and the inner and outer PET layer thicknesses were almost the same.

The preform was subjected to formation of a bottle (inner volume of 300 mL, average thickness of about 320 μm at a body part) by means of stretching blow molding machine (made by Frontier K.K.) The heating time of the preform was about 40-60 sec., and the preform surface temperature immediately before the blowing was about 100-120° C.

### Example 2

A preform was obtained and blow molding was performed in the same manner as in Example 1 except for changing the blend ratio to 3 wt. parts of the PET (Ge) to 100 wt. parts of the PGA.

### Example 3

100 wt. parts of the PGA and 3 wt. part PET(germanium) were blended uniformly in a dry state, and the blend was melt-kneaded through a twin-screw extruder equipped with a feeder (“LT-20”, made by K.K. Toyo Seiki Seisakusyo) under the extrusion conditions shown below to form melt-kneaded PGA-PET pellets. Then, a preform was obtained and blow molding was performed in the same manner as in Example 2 except that the melt-kneaded PGA-PET pellets were used instead of the PGA-PET pellet blend in Example 2 and the setting of the core-layer injection molding machine was changed to a cylinder temperature of 250° C. and a hot runner temperature of 250° C.

(Extrusion Conditions)

### Temperature: C1:220° C., C2:250° C., C3:255° C., C4:230° C.

Screw rotation speed: 30 rpm
Feeder rotation speed: 20 rpm
Residence time in the extruder: about 5 minutes.

### Example 4

A preform was obtained and blow molding was performed in the same manner as in Example 1 except for changing the blend ratio to 5 wt. parts of the PET (Ge) to 100 wt. parts of the PGA.

### Example 5

A preform was obtained and blow molding was performed in the same manner as in Example 1 except that the blend ratio was changed to 5 wt. parts of the PET (Ge) to 100 wt. parts of the PGA, and the setting of the core-layer injection molding machine was changed to a cylinder temperature of 270° C. and a hot runner temperature of 270° C.

### Example 6

A preform was obtained and blow molding was performed in the same manner as in Example 5 except for changing the blend ratio to 10 wt. parts of the PET (Ge) to 100 wt. parts of the PGA.

### Example 7

A preform was obtained and blow molding was performed in the same manner as in Example 1 except for changing the extrusion rates of the inner and outer layer PET resin and the core layer PGA-PET blend resin. The weight of the obtained preform was about 21 g, the weight of the core layer occupied 2.5 to 3.5% of the whole preform weight, and the inner and outer PET layer thicknesses were almost the same.

### Comparative Example 1

A preform was obtained and blow molding was performed in the same manner as in Example 6 except for using a blend of 100 wt. parts of the PGA and 10 wt. parts of PET (Sb) obtained by using an antimony catalyst (“1101” made by KoSa Co.; antimony content: 201 ppm, phosphorus content: 8.1 ppm; melting point: about 250° C.

### Comparative Example 2

A preform was obtained and blow molding was performed in the same manner as in Example 1 except that the PGA pellets alone were used instead of the PGA-PET pellet blend, and the cylinder temperature was set to 240° C. and the hot runner temperature was set to 250° C.

The outlines and evaluation results of the obtained compositions are inclusively shown in the following Table 1.

TABLE 1

| | Example | | | | | | | | |
|---|---|---|---|---|---|---|---|---|---|
| | 1 | 2 | 3 | 4 | 5 | 6 | 7 | Comp. 1 | Comp. 2 |
| Material blended to core layer PGA | PET (Ge) | | | | | | | PET (Sb) | PGA |
| Blend amount [phr] | 1 | 3 | 3*2 | 5 | 5 | 10 | 1 | 10 | alone |
| Core layer injection conditions [CT/HR] | 255/255 | →*3 | 250/250 | 255/255 | 270/270 | → | 255/255 | 270/270 | 240/250 |
| Blow temperature [° C.] | 100-120 | → | → | → | → | → | → | → | → |
| Amount of decomposition (GL content) [%] | 0.06 | 0.12 | 0.04 | 0.06 | 0.18 | 0.07 | 0.06 | 0.65 | 0.05 |
| Carboxylic acid concentration [eq/t] | 5.0 | 5.7 | 5.0 | 4.2 | 4.7 | 8.6 | 1.2 | 9.6 | 5.2 |
| Time to decreased molecular weight of | 6.0 | 5.9 | 6.0 | 5.9 | 4.5 | 4.2 | 6.5 | 2.6 | 6.1 |
| 70,000 in 50° C.-90% [days] | | | | | | | | | |
| Surface roughness [nm] | 4.8 | 8.7 | 4.4 | 13.0 | 19.8 | 12.1 | 5.2 | 12.5 | 3.0 |
| Number of peeled bottles (/20)*1 | 1 | 1 | 0 | 0 | 0 | 2 | 1 | 2 | 4 |

*1Number of bottles having caused peeling among the tested 20 bottles.
*2PGA-PET melt-kneaded pellets were used only in Example 3, and PGA-PET pellet blends were used in all other Examples.
*3“→” represents the same as the left.

The results shown in Table 1 above reveal the following. In the laminate bottles having a layer structure of PET/core layer/PET, the laminate bottles of the present invention (Examples 1-7) wherein a small amount of PET (Ge) was blended to PGA forming the core layer, exhibited a remarkably improved peeling resistance as a result of an increased surface roughness of the core layer, compared with a laminate bottle having a core layer formed of PGA alone (Comparative Example 2), without a noticeable increase in glycolide (GL) content due to decomposition of PGA so that the decrease in gas-barrier-persistent time (number of days in which the molecular weight was lowered to 70,000 in a decomposition-accelerating atmosphere of 50° C./90% RH) was within a tolerable limit. Particularly, in Example 3 wherein the melt-kneaded pellets of PGA and PET were prepared in advance and supplied to the injection molding machine, very little decomposed glycolide (GL) generation was observed in consideration of a small amount of PET addition, and the gas-barrier persistency is also good. On the other hand, Comparative Example 1 wherein PET (Sb) was blended instead of PET (Ge), provided an acceptable peeling resistance-improvement effect, but also resulted in remarkable decomposed glycolide (GL) formation and, correspondingly, a remarkable reduction of gas-barrier persistency.

### INDUSTRIAL APPLICABILITY

As described above, according to the present invention, there is provided a laminate having a layer structure of PET/core layer PGA/PET having a remarkable improvement in practical peeling resistance while well retaining a gas-barrier persistency duration, by blending a small amount of an aromatic polyester resin (Ge) formed by polymerization using a germanium compound (catalyst) to the core layer PGA of the laminate.

1. A peeling-resistant gas-barrier laminate, comprising a pair of aromatic polyester resin layers, and a gas-barrier resin layer sandwiched between the aromatic polyester resin layers; wherein the gas-barrier property resin layer comprises a mixture of 100 wt. parts of a polyglycolic acid resin and 1-10 wt. parts of an aromatic polyester resin polymerized with a germanium compound (catalyst), and the gas-barrier resin layer is provided with a surface roughness of 4-1000 nm.

2. A laminate according to claim 1, wherein the polyglycolic acid resin contains 0.001-5 wt. parts of a thermal stabilizer per 100 wt. parts thereof.

3. A laminate according to claim 1, wherein the polyglycolic acid resin contains a carboxyl group-capping agent in an amount of at most 1 wt. % thereof.

4. A laminate according to claim 1, wherein the gas-barrier resin layer has been formed from melt-kneaded pellets of the polyglycolic acid resin and the aromatic polyester resin prepared in advance.

5. A laminate according to claim 1, wherein the aromatic polyester resin forming the gas-barrier resin layer comprises polyethylene terephthalate polymerized with a germanium compound (catalyst).

6. A laminate according to claim 1, wherein the aromatic polyester resin forming the pair of aromatic polyester resin layers, comprises polyethylene terephthalate.

7. A laminate according to claim 6, wherein the aromatic polyester resin forming the pair of aromatic polyester resin layers, comprises polyethylene terephthalate polymerized with an antimony compound (catalyst).

8. A laminate according to claim 1, which has been stretched in at least one direction.

9. A laminate according to claim 1, which has a shape of a hollow container.

10. A laminate according to claim 9, which has been formed by injection blow molding.
